(19) United States
(12) Patent Application Publication
(10) Pub. No.: US 2009/0262115 A1
(43) Pub. Date: Oct. 22, 2009

(54) Method for Creating a Graphical Representation of a String of Alphanumeric Characters

(76) Inventor: Charles Allen Christenson, II, Omaha, NE (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/258,096

(22) Filed: Oct. 24, 2008

Related U.S. Application Data
(60) Provisional application No. 61/046,224, filed on Apr. 18, 2008.

(51) Int. Cl. G06T 11/20

(52) U.S. Cl. 345/443

(57) ABSTRACT

A method for creating a graphical representation of a string of alphanumeric characters is disclosed. The method comprises determining a key position on a telephone keypad corresponding to each of the alphanumeric characters in the string, including a first key position for the first alphanumeric character, intermediate key positions for the intermediate alphanumeric characters, and a last key position for the last alphanumeric character. Then, a plurality of lines are successively generated from the first key position to each of the intermediate key positions to the last key position on the telephone keypad so as to create the graphical representation of the string of alphanumeric characters. Marking insignia are optionally generated to signify the beginning and end of the graphical representation. The method may be implemented by a computer.

### CROSS-REFERENCE TO RELATED APPLICATIONS

This application is based on and claims priority to U.S. Provisional Patent Application Ser. No. 61/046,224, filed on Apr. 18, 2008, which is incorporated herein by reference.

### STATEMENT REGARDING FEDERALLY SPONSORED RESEARCH OR DEVELOPMENT

Not applicable.

### FIELD OF THE INVENTION

The present invention is directed to graphical representations of strings of alphanumeric characters and, more particularly, to a method for creating a graphical representation of a string of alphanumeric characters which utilizes the layout of a standard telephone keypad to create a word/number sign corresponding to the alphanumeric characters in the string.

### BACKGROUND OF THE INVENTION

It is a common practice in the field of advertising and marketing to connect a particular word or phrase associated with a commercial enterprise with a particular phone number by substituting the numbers in the phone number with the corresponding letters as taken from the standard telephone keypad. For example, if a company used as one of its associated words or phrases the word “numbers,” it might choose to obtain the toll-free number corresponding to the word “numbers” such that its advertising would be directed to the phone number 1-800-NUMBERS. This, of course, would correspond to the phone number 1-800-686-2377, which are the numbers on the standard telephone keypad corresponding to the selected letters in the phone number 1-800-NUMBERS. Although connection of a word or phrase to a string of numbers has served the purpose of providing recognizable phone numbers, it is believed that generation of a graphical representation of a string of alphanumeric characters (e.g., a word or phrase associated with a company) may provide even greater identification and recognition from an advertising standpoint.

### BRIEF SUMMARY OF THE INVENTION

The present invention is directed to a method for creating a graphical representation of a string of alphanumeric characters (i.e., letters and/or numbers) comprising a first alphanumeric character, one or more intermediate alphanumeric characters and a last alphanumeric character. The method utilizes the key configuration or layout of a standard telephone keypad to create a word/number sign corresponding to the alphanumeric characters in the string. In an exemplary embodiment, the method comprises creating the word/number sign by starting at the key location that corresponds to the first character in the string, drawing a line to the key location that corresponds to the next character in the string, and so on until the line ends at the key location corresponding to the last character in the string. As such, the alphanumeric string is represented by a series of lines connecting the representational key locations of the standard telephone keypad. Preferably, start and end symbols are provided to illustrate the beginning and end of the word/number sign. The method of the present invention may be computer-implemented such that the word/number sign is created by a software application that is preferably accessible via a web page on the Internet.

### BRIEF DESCRIPTION OF THE DRAWINGS

FIG. 1 is a pictorial representation of a standard telephone keypad with a word/number sign for the word “Christian” drawn thereon in accordance with a first exemplary embodiment of the present invention;

FIG. 2 is a pictorial representation of the “number 2” key of the standard telephone keypad of FIG. 1, wherein the key is subdivided into eight sections to handle multiple hits on the key;

FIG. 3 is a pictorial representation of a key of the standard telephone keypad subdivided into eight sections with a word/number sign for the word “cab” drawn thereon in accordance with a second exemplary embodiment of the present invention; and

FIG. 4 is a perspective view of an individual wearing a shirt having the word/number sign of FIG. 1 imprinted thereon for display.

### DETAILED DESCRIPTION OF EXEMPLARY EMBODIMENTS OF THE INVENTION

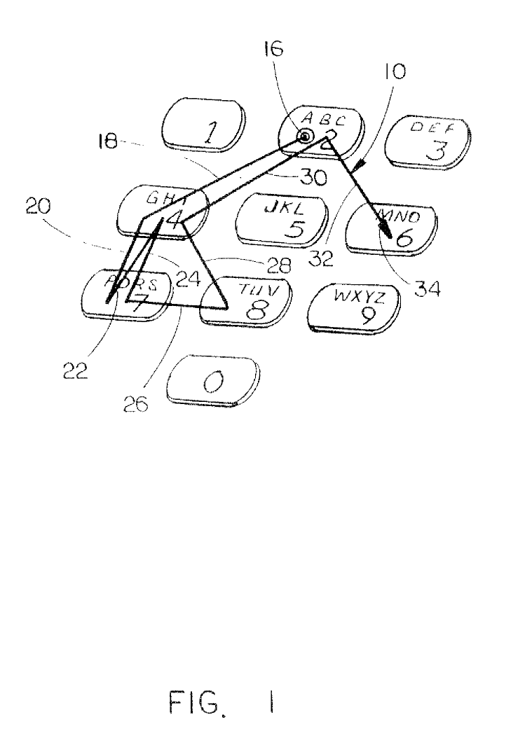

A method for creating a graphical representation (also referred to as a word/number sign) of a string of alphanumeric characters in accordance with a first exemplary embodiment of the present invention will be described with reference to FIG. 1. As shown in FIG. 1, the standard telephone keypad includes ten number buttons or keys that are numbered 1, 2, 3, 4 5, 6, 7, 8, 9 and 0. The numbers 1, 2 and 3 are positioned in the top row, the numbers 4, 5 and 6 are positioned in the second row, the numbers 7, 8 and 9 are positioned in the third row, and the number 0 is positioned in the bottom row, centered and aligned vertically with the middle column of numbers. Each of the numbers except for 1 and 0 have letters associated therewith. Specifically, the letters A, B and C are associated with the number 2 key; the letters D, E and F are associated with the number 3 key; and so on and so forth as shown in FIG. 1.

A word/number sign 10 is created on the standard telephone keypad by starting at the first number or letter in the alphanumeric character string, then drawing a line to each subsequent number or letter in the alphanumeric character string until reaching the last letter or number in the alphanumeric character string. For example, if one were to make a sign using the name “Christian,” one would start at the number 2 (because that is the key where the letter “C” is located), draw a line 18 from the number 2 to the number 4 (“H”), draw a line 20 from the number 4 to the number 7 (“R”), draw a line 22 from the number 7 back to the number 4 (“I”), draw a line 24 from the number 4 back to the number 7 (“S”), draw a line 26 from the number 7 to the number 8 (“T”), draw a line 28 from the number 8 back to the number 4 (“I”), draw a line 30 from the number 4 back to the number 2 (“A”), and finally draw a line 32 from the number 2 to the number 6 (“N”). A graphical representation of the name “Christian” is thus obtained.

Although the word/number sign 10 is illustrated in FIG. 1 as a series of lines connecting the various number keys, the lines may be represented in various thicknesses, sizes, shapes, colors and designs in order to enhance the aesthetic appearance of the graphical representation of the string of alphanumeric characters. In addition, changing the shape of the keys and/or rearranging the location of the keys within reasonable limits will not significantly affect the method for creating the graphical representation of the string of alphanumeric characters.

It should be understood that the method of the present invention can be used with virtually any string of alphanumeric characters, be it a phone number name, phrase, slogan, business name, or any other such string of characters. For example, if one were to make a sign using a phone number, one would start at the first number in the string of numbers, then draw a line to each subsequent number in the string of numbers until reaching the last number in the string of numbers. Each of the graphical representations produced in accordance with the present invention will be generally unique, although it is theoretically possible to have identical word/number signs that represent different strings of numbers or letters due to the fact that the standard telephone keypad has multiple letters on each of the keys (except the 1 and 0 keys).

Referring still to FIG. 1, the word/number sign 10 preferably includes a bulls-eye, dot or other desired marking insignia to signify the first alphanumeric character in the string, as well as an arrowhead or other desired marking insignia to signify the last alphanumeric character in the string. In the example shown in FIG. 1, the bulls-eye or dot is placed on the number 2 key corresponding to the letter “C” (i.e., the first letter in the name “Christian”), and the arrowhead is placed on the number 6 key corresponding to the letter “N” (i.e., the last letter in the name “Christian”). In this manner, the beginning and end points of the string of alphanumeric characters may be determined by an individual viewing the word/number sign 10. It should also be noted that numerous other types of marking insignia may be used to signify the beginning and end points of the word/number sign 10, and these may be selected based on various criteria determined by the user of the present invention. Of course, a word/number sign could be created without any marking insignia.

It can be appreciated that many strings of alphanumeric characters include letters or numbers that are identical. These identical letters or numbers may be adjacent one another in the string or spaced throughout the string. Further, because each of the number keys on the standard telephone keypad include multiple letters thereon (except the 1 and 0 keys), it is entirely possible for a word or phrase to hit a number key more than once even when a different letter is being represented. For example, referring to the word/number sign for the word “Christian” shown in FIG. 1, it can be seen that the number 2 key is hit twice, the number 4 key is hit three times, and the number 7 key is hit twice as the graphical representation of the word “Christian” is being created. In order to address this issue, each of the number keys on the standard telephone keypad is preferably subdivided into a predetermined number of different sections. The sectioning of the number keys is designed to permit the key to be hit in a different location each time the number or letter associated with that key is hit in the string of alphanumeric characters.

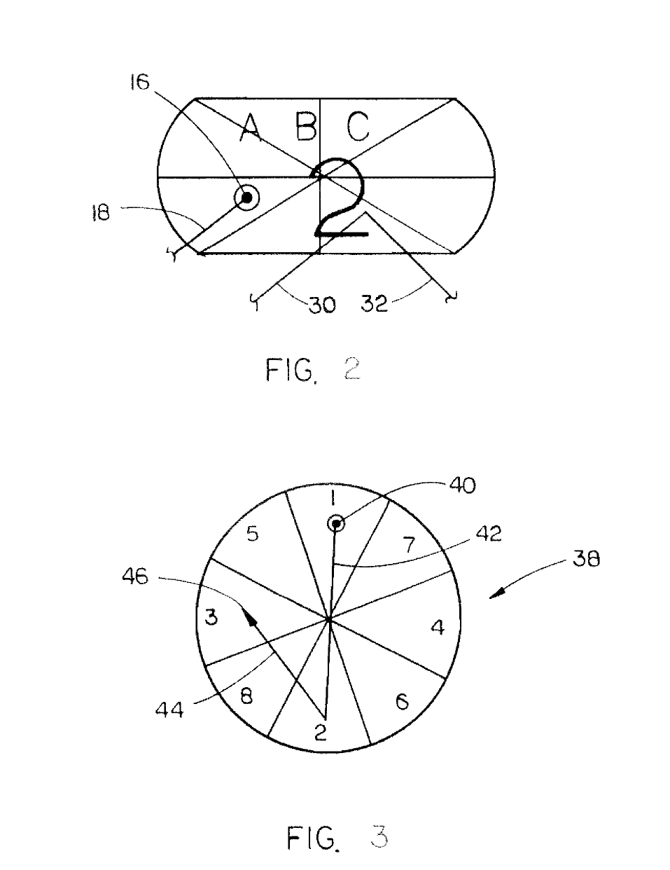

For example, referring to FIG. 2, it can be seen that the number 2 key from FIG. 1 has been subdivided into eight generally wedge-shaped sections. The bulls-eye 16 and beginning of line 18 (which was generated based on the first letter “C”) is located in a different section on the number 2 key than the intersection of lines 30 and 32 (which were generated based on the letter “A”). As such, line 18 is spaced a distance from lines 30 and 32. The word/number sign 10 is thus able to illustrate that the keys are hit in a particular sequence, instead of merely writing over previously created line connections between the number keys.

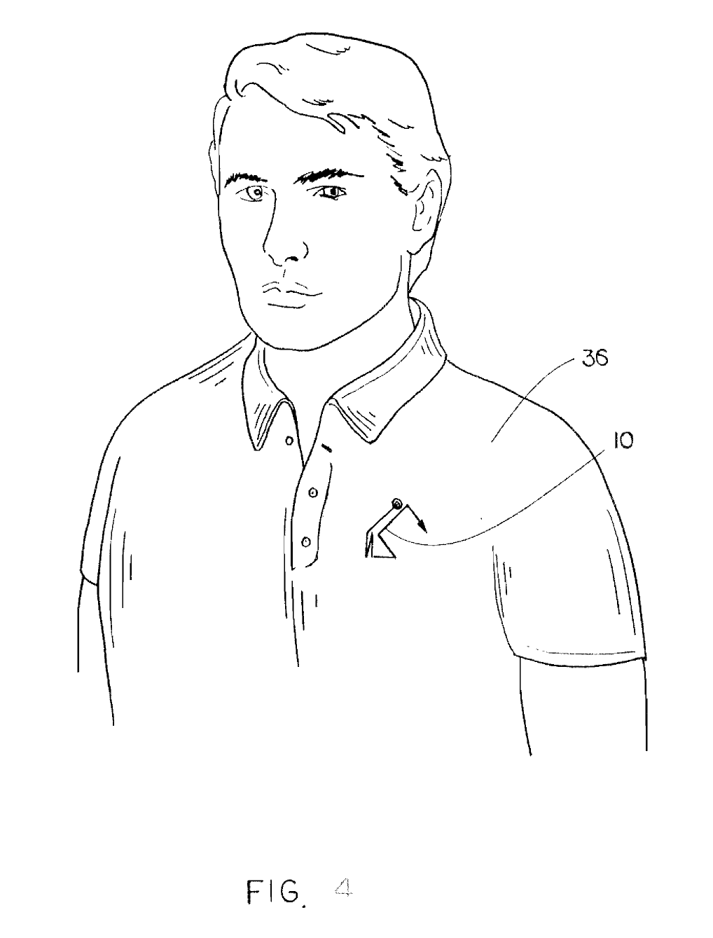

Referring to FIG. 3, a second exemplary embodiment of the method of the present invention is provided to further describe the sectioning of the number keys. FIG. 3 shows a word/number sign 38 representing the word “cab,” wherein all three letters of the word “cab” are located on the number 2 key of the standard telephone keypad (the numbers and letters on the key are not shown for clarity). It can be seen that the number 2 key is circular and subdivided into eight sections. Each section is numbered from 1 to 8 to represent the order in which the sections are hit when more than one character in the string corresponds with the number 2 key. It should be understood that although only the number 2 key is shown, each of the other keys of the standard telephone keypad would be subdivided in the same manner.

In order to create word/number sign 38, a bulls-eye 40 is placed in the first section of the number 2 key to signify the beginning point of the sign (“C”). A line 42 is then drawn from the bulls-eye 40 in the first section to the second section (“A”), and another line 44 is drawn from the second section to the third section (“B”). Finally, an arrowhead 46 is placed at the end of line 44 to signify the end point of the sign. Thus, word/number sign 38 consists of two distinct lines representing a string of three characters all of which correspond to the number 2 key. It can be appreciated that if the number 2 key were not sectioned as described above, then the sign for the word “cab” would consist of the end point (i.e., arrowhead 46) superimposed on top of the beginning point (i.e., bulls-eye 40). Of course, it should be understood that the ordering of the sections of the number 2 key could be altered, shuffled, rotated or customized in any manner so as to create a sign having a different appearance.

Alternatively, the number of sections for any particular key may based on the number of alphanumeric characters in the string that correspond to that key. For example, when representing the word “cab,” the number 2 key may be subdivided into three sections (i.e., one for each of the three letters corresponding to the number 2 key —“C,” “A,” and “B”). However, it is preferred that the number of sections on a particular key be predetermined and not based on the number of alphanumeric characters in the string that correspond to that key. It should also be understood that the sequence in which the sections on the key are hit may be predetermined (as in the embodiment shown in FIG. 3), or may be determined in a manner that minimizes the number of crossed lines within the sign. Additionally, although the key sections shown in FIGS. 2 and 3 are generally wedge-shaped, the sections may have any desired shape in accordance with the present invention.

FIG. 4 illustrates one of the potential uses for the word/number signs of the present invention, specifically in creating an individual word/number sign 10 on a shirt 36 or the like. The word/number sign 10 may be recognizable from the example of FIG. 1 as being the graphical representation of the name “Christian.” It can be seen that the word/number sign 10 is displayed on the shirt 36 without the image of the standard telephone keypad. The word/number sign 10 may generate significant interest from onlookers and thus create opportunities for interaction between onlookers and the individual wearing the shirt 36. Of course, the word/number sign 10 may be affixed to or imprinted on the shirt 36 in any appropriate manner, any of which would be understood by a person skilled in the art of shirt design and construction. In addition to clothing, the word/number sign may be displayed on any object or medium, including, but not limited to, signs, advertisements, business cards, web pages and the like.

It should be noted that the method of the present invention may be used to graphically represent virtually any string of alphanumeric characters, and may be of particular interest for use by a business who is interested in creating a unique logo to be used in connection with the name of the business. The word/number sign for a business name created in accordance with the present invention would be generally unique to that business, and therefore, could be used in place of or in connection with the business name to provide additional identification for the business. Further, the word/number sign could be used to generate interest in the business. The applications for the word/number sign are only limited by the imagination of the user of the present invention and, thus, it is believed that the present invention provides a unique and beneficial system by which graphical representations of strings of alphanumeric characters may be generated.

It should be understood that the method of the present invention may be encoded as a computer software program which generally performs the steps described above to create the word/number sign associated with a particular string of alphanumeric characters. The encoding of the method is believed to be well within the knowledge of a person skilled in the art of computer software programming and design. It should be understood that such a computer software program may be offered or packaged in any manner. For example, the computer software program could be downloadable from the Internet or stored on a computer-readable medium whereby the word/number sign is displayed on a computer screen. Additionally, the computer software program may be provided as application software accessible through a web site on the Internet.

In one example of the computer-implemented method of the present invention, a server system and associated storage device are provided so that the application software is accessible through a web site on the Internet. The key configuration or layout of the standard telephone keypad is stored and used by the application software to create the word/number signs for any desired string of alphanumeric characters. The web site preferably displays a web page with a user input field for receiving a desired string of alphanumeric characters from a user. Preferably, after the application software creates the word/number sign, it is displayed on the web page for viewing by the user. The application software may also have an option to alter the number and/or arrangement of sections on the keys in order to change the appearance of the word/number sign associated with a particular string of alphanumeric characters, as described above.

While the method for creating a graphical representation of a string of alphanumeric characters has been described and illustrated hereinabove with reference to several exemplary embodiments, it should be understood that various modifications could be made to these embodiments without departing from the scope of the present invention. For example, although the method has been described and illustrated in connection with the key configuration of a standard telephone keypad, other predetermined key configurations could also be used in accordance with the present invention. Therefore, the present invention is not to be limited to the exemplary embodiments described and illustrated hereinabove, except insofar as such limitations are included in the following claims.

What is claimed and desired to be secured by Letters Patent is as follows:

1. A method for creating a graphical representation of a string of alphanumeric characters using a telephone keypad, wherein said string comprises a first alphanumeric character, one or more intermediate alphanumeric characters and a last alphanumeric character, said method comprising:
determining a key position on said telephone keypad corresponding to each of said alphanumeric characters, including a first key position for said first alphanumeric character, one or more intermediate key positions for said intermediate alphanumeric characters, and a last key position for said last alphanumeric character;
successively generating a plurality of lines from said first key position to each of said intermediate key positions to said last key position on said telephone keypad so as to create said graphical representation of said string of alphanumeric characters.

2. The method of claim 1, further comprising generating a marking insignia on said line originating from said first key position so as to signify a beginning point of said graphical representation.

3. The method of claim 1, further comprising generating a marking insignia on said line terminating at said last key position so as to signify an end point of said graphical representation.

4. The method of claim 1, wherein a key position on said telephone keypad corresponds to at least first and second alphanumeric characters within said string, wherein said key position is subdivided into at least first and second sections, and wherein said lines associated with said first and second alphanumeric characters are generated so as to intersect said first and second sections of said key position, respectively.

5. The method of claim 1, further comprising displaying said graphical representation on an object.

6. A computer-implemented method for creating a graphical representation of a string of alphanumeric characters using a telephone keypad, wherein said string comprises a first alphanumeric character, one or more intermediate alphanumeric characters and a last alphanumeric character, said computer-implemented method comprising:
receiving said string of alphanumeric characters;
determining a key position on said telephone keypad corresponding to each of said alphanumeric characters, including a first key position for said first alphanumeric character, one or more intermediate key positions for said intermediate alphanumeric characters, and a last key position for said last alphanumeric character; and
generating a plurality of lines from said first key position to each of said intermediate key positions to said last key position on said telephone keypad so as to create said graphical representation of said string of alphanumeric characters.

7. The computer-implemented method of claim 6, further comprising storing a key configuration of said telephone keypad.

8. The computer-implemented method of claim 6, further comprising displaying said graphical representation of said string of alphanumeric characters on a display screen.

9. The computer-implemented method of claim 6, further comprising presenting a web page with a user input field for receiving said string of alphanumeric characters.

10. The computer-implemented method of claim 9, further comprising displaying said graphical representation of said string of alphanumeric characters on said web page.

11. The computer-implemented method of claim 6, further comprising generating a marking insignia on said line originating from said first key position so as to signify a beginning point of said graphical representation.

12. The computer-implemented method of claim 6, further comprising generating a marking insignia on said line terminating at said last key position so as to signify an end point of said graphical representation.

13. The computer-implemented method of claim 6, wherein a key position on said telephone keypad corresponds to at least first and second alphanumeric characters within said string, wherein said key position is subdivided into at least first and second sections, and wherein said lines associated with said first and second alphanumeric characters are generated so as to intersect said first and second sections of said key position, respectively.

14. A method for creating a graphical representation of a string of alphanumeric characters using a predetermined key configuration, wherein said string comprises a first alphanumeric character, one or more intermediate alphanumeric characters and a last alphanumeric character, said method comprising:
determining a key position corresponding to each of said alphanumeric characters, including a first key position for said first alphanumeric character, one or more intermediate key positions for said intermediate alphanumeric characters, and a last key position for said last alphanumeric character;
successively generating a plurality of lines from said first key position to each of said intermediate key positions to said last key position so as to create said graphical representation of said string of alphanumeric characters.

15. The method of claim 14, wherein said predetermined key configuration comprises a key configuration of a telephone keypad.

16. A computer-implemented method for creating a graphical representation of a string of alphanumeric characters using a predetermined key configuration, wherein said string comprises a first alphanumeric character one or more intermediate alphanumeric characters and a last alphanumeric character, said computer-implemented method comprising:
receiving said string of alphanumeric characters;
determining a key position corresponding to each of said alphanumeric characters, including a first key position for said first alphanumeric character, one or more intermediate key positions for said intermediate alphanumeric characters, and a last key position for said last alphanumeric character; and
generating a plurality of lines from said first key position to each of said intermediate key positions to said last key position so as to create said graphical representation of said string of alphanumeric characters.

17. The computer-implemented method of claim 16, wherein said predetermined key configuration comprises a key configuration of a telephone keypad.

18. A computer-implemented method for creating a graphical representation of a string of alphanumeric characters using a telephone keypad, wherein said string comprises a first alphanumeric character, one or more intermediate alphanumeric characters and a last alphanumeric character, said computer-implemented method comprising:
presenting a web page with a user input field for receiving said string of alphanumeric characters;
receiving said string of alphanumeric characters in said user input field;
determining a key position on said telephone keypad corresponding to each of said alphanumeric characters, including a first key position for said first alphanumeric character, one or more intermediate key positions for said intermediate alphanumeric characters, and a last key position for said last alphanumeric character;
generating a plurality of lines from said first key position to each of said intermediate key positions to said last key position on said telephone keypad so as to create said graphical representation of said string of alphanumeric characters; and
displaying said graphical representation of said string of alphanumeric characters on said web page.
